(19) United States
(12) Patent Application Publication
(10) Pub. No.: US 2005/0111959 A1
(43) Pub. Date: May 26, 2005

(54) PALLET CONTAINMENT SYSTEM

(75) Inventor: H. Thad German, Belding, MI (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(73) Assignee: RAPISTAN SYSTEMS ADVERTISING CORP., Grand Rapids, MI (US)

(21) Appl. No.: 10/904,360

(22) Filed: Nov. 5, 2004

Related U.S. Application Data
(60) Provisional application No. 60/481,606, filed on Nov. 6, 2003.

(51) Int. Cl. B66C 3/00

(52) U.S. Cl. 414/785

(57) ABSTRACT

A pallet-handling device includes a support service adapted to supporting a pallet and at least one grasping arm. The at least one grasping arm grasps a portion of a pallet when in a pallet-grasping state. The pallet-handling device further includes an actuator. The actuator is responsive to a pallet at the support plate to cause the at least one grasping arm to be in the pallet grasping state.

### CROSS REFERENCE TO RELATED APPLICATION

This application claims priority from U.S. provisional patent application Ser. No. 60/481,606, filed on Nov. 6, 2003, the disclosure of which is hereby incorporated herein by reference in its entirety.

### BACKGROUND OF INVENTION

The present invention is directed to a material-handling system and, in particular, to a material-handling system for handling pallets. Such pallets are used to support one or more articles in a load.

Pallets are designed primarily to be handled by forklift trucks. Thus, there are typically openings for the truck forks to engage the pallet from any side of the pallet. One such pallet, known as a “GMA” style pallet, is illustrated in FIG. 5. Pallet 50 includes a plurality of deck boards 52, which are fastened to vertical stringers 54. The bottoms of the stringers are joined by bottom slats 58. In order to engage the GMA style pallet from the side, a pair of cutouts 56 is provided for receiving the forks of the truck.

Automated material-handling systems are available that handle pallet 50 without the use of forks. In a known automated material-handling system 110, pallet 50 is supported in a rest position by blocks, or rails, 60 (FIG. 5). By way of example, in an automatic storage and retrieval system (ASRS), a carriage (not shown) includes a pair of blocks 60, which supports the pallet in a rest position. A pallet-handling device 112 is supported by a pair of supports 15 of system 110 and includes a pallet support plate 114 which is used to lift the pallet and transport the pallet, such as to a location on a rack. Another pair of blocks or rails 60 is at each location in the rack in order to, again, supports the pallet when in storage in the rack.

A difficulty with the pallet-handling device 112 in FIG. 5 is that, because of the presence of cutouts 56, a pivot point P exists between the pallet support plate 114 and the deck board 58 closest to the cutout. Thus, an uneven load having a center of gravity outside of point P may cause the entire pallet and load to pivot about point P and thereby tip and dump the articles on the pallet. While solutions have been proposed to this vexing problem, none have been entirely satisfactory.

### SUMMARY OF INVENTION

A pallet-handling device, which is capable of stably transporting a pallet loaded with articles, is provided according to the invention. According to an aspect of the invention, a pallet-handling device includes a support service adapted to supporting a pallet and at least one grasping arm. The at least one grasping arm grasps a portion of a pallet when in a pallet-grasping state. The pallet-handling device further includes an actuator. The actuator is responsive to a pallet at the support plate to cause the at least one grasping arm to be in the pallet grasping state.

In this manner, a pallet is securely grasped by the pallet-handling device, both while being raised and lowered and during transportation thereby significantly reducing the likelihood of spillage of the articles being supported by the pallet.

These and other objects, advantages and features of this invention will become apparent upon review of the following specification in conjunction with the drawings.

### BRIEF DESCRIPTION OF DRAWINGS

FIG. 1 is a side elevation of a pallet containment system, according to an embodiment of the invention;

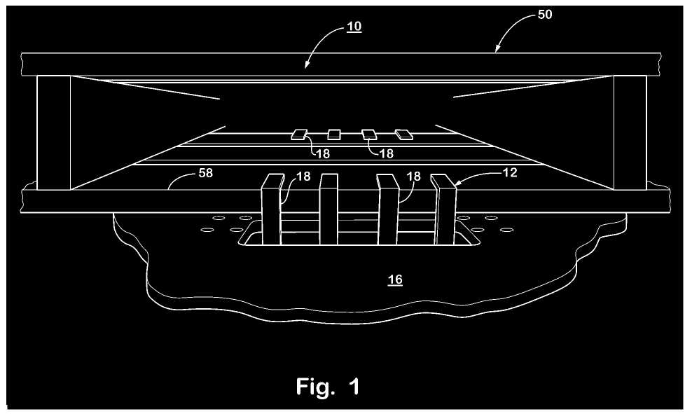

FIG. 2 is an end elevation of the pallet containment system in FIG. 1;

FIG. 3 is a bottom plan view of the pallet containment system in FIG. 2;

FIG. 4 is the same view as FIG. 2 with the pallet being grasped by the pallet containment system; and

FIG. 5 is the same view as FIG. 4 of a prior art pallet-handling device.

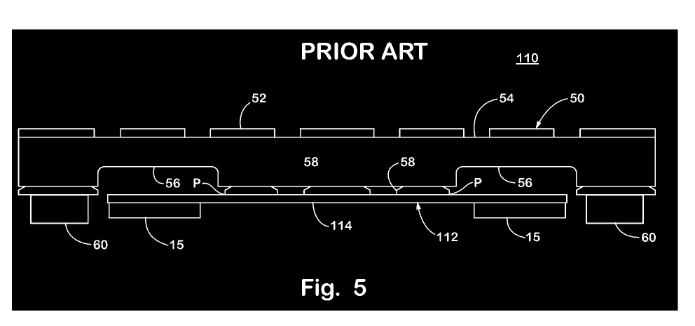

### DESCRIPTION OF THE PREFERRED EMBODIMENT

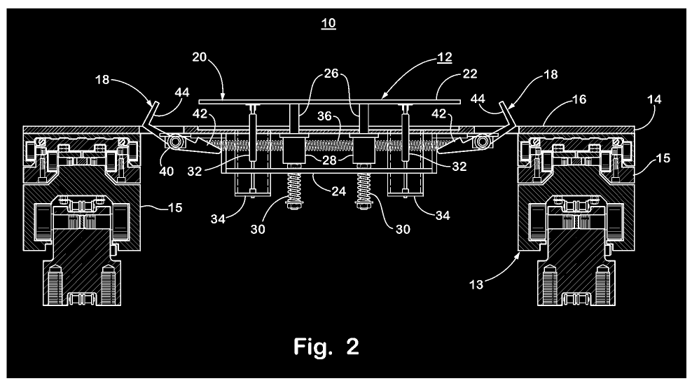

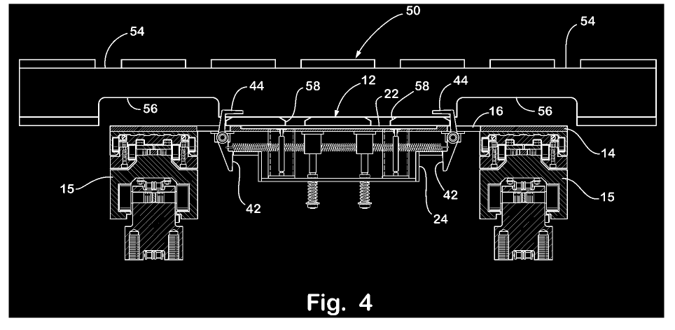

Referring now specifically to the drawings, and the illustrative embodiments depicted therein, a pallet containment system 10 includes a pallet-handling device 112, which is supported by a load-handling device 13 (FIGS. 2 and 4). The load-handling device includes a pair of supports 15. Examples of load-handling devices with which the pallet-handling device 112 is compatible include, without limitation, automatic storage and retrieval systems (ASRS), automatic-guided vehicles (AGVs), forklift trucks, and the like. In the illustrative embodiment, the load-handling device is an ASRS having a pair of supports 15 which are multiple extendable members as is well known in the art. Pallet-handling device 112 includes a pallet support plate 14, which is carried by supports 15 of load-handling device 13. Pallet support plate 14 includes a support surface 16, which carries the pallet 50 during transport of the pallet.

Pallet-handling device 112 includes an actuator assembly 20 and one or more grasping arms 18. Actuator assembly 20 includes a plunger 22 and a clamp plate 24 which are interconnected by shafts 26. Shafts 26 ride in linear bearings 28 such that shafts 26 are capable of vertical reciprocation. A compression spring 30 on each shaft 26 provides an energy bypass mechanism to absorb any impact applied to grasping arms 18.

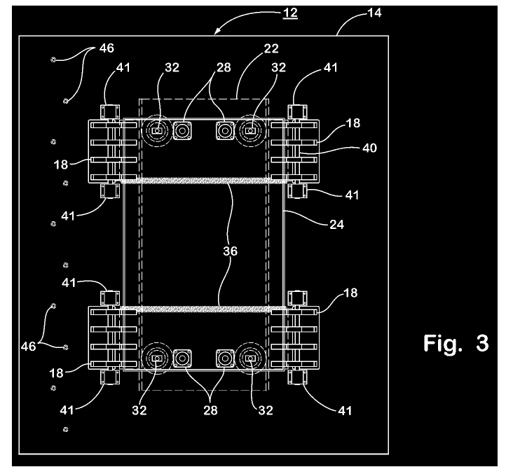

Grasping arms 18 are pivotally supported by a shaft 40, which is supported by pillow block bearings 41. As can been seen in FIG. 3, grasping arms 18 may be grouped together in multiple assemblies, which, in the illustrative embodiment, includes four assemblies of grasping arms, each supported by a shaft and a pair of pillow block bearings. Each grasping arm 18 includes a grasping finger 44, which is a general L-shape, and a cam surface 42 opposite finger 44. Grasping arms 18 are biased in a non-grasping state. As illustrated in FIG. 2, by an extension spring 36 extending between opposing sets of grasping arms, other techniques, such as weights or other spring arrangements, may also be utilized to bias grasping arms in a non-grasping state.

One or more compression devices, such as gas springs 32, are used to bias actuator assembly 20 in a non-actuated position. In the illustrative embodiment, the non-actuated position of actuator assembly 20 is with plunger 22 elevated above support surface 16.

In operation, the load-handling device positions pallet-handling device 112 under a pallet 50. Upward movement of load-handling device 13 applies the weight of the pallet to actuator assembly 20. Further upward movement of the load-handling device causes plunger assembly 20 to move downwardly. The downward movement causes clamp plate 24 to engage cam surfaces 42 of grasping arms 18 thereby moving grasping fingers 44 towards each other. Such movement also extends expansion spring 36. This inward movement of fingers 44 causes the fingers to extend above bottom slats 58 of the pallet. This causes the grasping arm to grasp a bottom portion of the pallet in the grasping state illustrated in FIG. 4. The grasping arms will remain in the grasping state until the pallet is positioned on one or more rails or blocks 60. As the weight of the pallet and its contents are borne by rails 60, further downward movement of load-handling device 13 allows compression springs 32 to bias the actuator assembly upwardly. This allows the energy stored in expansion spring 36 to move grasping arms 18 to the non-grasping position illustrated in FIG. 2. This allows the pallet-handling device to move freely below the pallet and thereby be retracted by the load-handling device from the pallet.

The illustrated embodiment is a fully mechanical implementation of the invention. This is especially useful for certain applications, such as attachments to ASRS, where the utilization of hydraulic hoses, electrical cables, or the like, would be difficult to accommodate with the wide range of motion of the support carriage with respect to the rest of the apparatus. Other applications may allow an embodiment wherein some or all of the actuation of the grasping arms is accomplished by hydraulic sensing of the pallet and actuation of the grasping arms or by electrical sensing of the pallet and actuation of the grasping arms, or some combination of both of these. Such implementation, in light of the teachings of the invention as provided herein, would be well within the skill of those knowledgeable in the art.

Changes and modifications in the specifically described embodiments can be carried out without departing from the principles of the invention which is intended to be limited only by the scope of the appended claims, as interpreted according to the principles of patent law including the doctrine of equivalents.

1. A pallet-handling device, comprising:
a support surface adapted to supporting a pallet;
at least one grasping arm, said at least one grasping arm grasping a portion of a pallet when in a pallet-grasping state; and
an actuator, said actuator responsive to a pallet at said support plate to cause said at least one grasping arm to be in said pallet-grasping state.

2. The pallet-handling device of claim 1 wherein said at least one grasping arm clamps the pallet against said support surface.

3. The pallet-handling device of claim 1 wherein said support surface is defined by an upper surface of a generally planar plate.

4. The pallet-handling device of claim 3 wherein said actuator comprises a plunger spaced from said upper surface when said at least one grasping arm is not in said grasping state.

5. The pallet-handling device of claim 4 wherein the weight of a pallet moves said plunger toward said upper surface and said plunger causes said at least one grasping arm to move to said pallet-grasping state.

6. The pallet-handling device of claim 5 including at least one compression spring biasing said plunger above said upper surface.

7. The pallet-handling device of claim 6 wherein said at least one compression spring comprises at least one gas spring.

8. The pallet-handling device of claim 4 including an energy bypass between said plunger and said at least one grasping arm, said energy bypass absorbing energy applied to said at least one grasping arm.

9. The pallet-handling device of claim 1 wherein said at least one grasping arm comprises a plurality of grasping arms.

10. The pallet-handling device of claim 9 wherein said plurality of grasping arms grasp the pallet in at least two spaced apart locations.

11. The pallet-handling device of claim 10 wherein said plurality of grasping arms grasp the pallet at two bottom slats.

12. The pallet-handling device of claim 10 including at least one spring biasing at least two spaced apart ones of said grasping arms away from said grasping state.

13. The pallet-handling device of claim 9 wherein said grasping arms are generally L-shaped.

14. The pallet-handling device of claim 1 wherein said at least one grasping arm is generally L-shaped.

15. The pallet-handling device of claim 1 in combination with a carriage of an automated storage and retrieval system.

16. The pallet-handling device of claim 1 in combination with an automated-guided vehicle.

17. The pallet-handling device of claim 1 in combination with a forklift truck.
